(19) United States
(12) Patent Application Publication
(10) Pub. No.: US 2015/0186998 A1
(43) Pub. Date: Jul. 2, 2015

(54) CALCULATING AND DISPLAYING PRICE COLLAR INDICATORS FOR MARKET DATA

(71) Applicant: Trading Technologies International, Inc., Chicago, IL (US)

(72) Inventor: Brian J. Buck, Livermore, CA (US)

(73) Assignee: Trading Technologies International, Inc., Chicago, IL (US)

(21) Appl. No.: 14/143,187

(22) Filed: Dec. 30, 2013

(51) Int. Cl. G06Q 40/04; G06T 11/20

(52) U.S. Cl. CPC G06Q 40/04; G06T 11/206

(57) ABSTRACT

Some embodiments of the invention provide systems and methods for displaying market data that are operatively configured to display, upon the triggering of a price collar trading period, visual indications of a current average price for a tradeable object, an upper price limit, a lower price limit and the duration of the price collar period through a trading interface.

### BACKGROUND

An electronic trading system generally includes a trading device in communication with an electronic exchange. The electronic exchange sends information about a market, such as prices and quantities, to the trading device. The trading device sends messages, such as messages related to orders, to the electronic exchange. The electronic exchange attempts to match quantity of an order with quantity of one or more contra-side orders.

It should be understood that the trading device may be any computing device, such as such as a personal computer, laptop computer, hand-held computer, tablet computer, smart phone or some other device that includes a display, user interface and includes hardware for communication with the electronic exchange.

Traders link to the electronic exchange through one or more networks to trade, that is, buy and sell tradeable objects. As used herein, the term “tradeable object” refers to anything that can be traded with a quantity and/or price. It includes, but is not limited to, all types of traded events, goods and/or financial products, which can include, for example, stocks, options, bonds, futures, currency, and warrants, as well as funds, derivatives and collections of the foregoing, and all types of commodities, such as grains, energy, and metals. The tradeable object may be “real,” such as products that are listed by an exchange for trading, or “synthetic,” such as a combination of real products that is created by the user. A tradeable object could actually be a combination of other tradeable objects, such as a class of tradeable objects.

Traders often use automated or semi-automated trading tools, collectively hereinafter referred to as automated tools, which automatically or semi-automatically send orders for tradeable objects to the exchange. Many different trading tools are usually provided to, among other things, facilitate fast and accurate order entry. For instance, an automated or semi-automated tool might quickly calculate one or more order parameters, such as order price or order quantity, based on market conditions, or some other reference condition, and then automatically send an order with these parameters to an exchange for matching.

Traders typically execute trading strategies that require the constant tracking of a large amount of individual tradeable objects and the need to assimilate large amounts of data in order to recognize market trends, view current market conditions, and quickly enter, cancel, update, and modify orders. Thus, traders employ specialized trading interfaces for assistance. Typical trading interfaces present a variety of information, which may include the status of each tradeable object in a line of numeric data fields covering key variables relevant to trading, such as price, quantity available at each price, the level of inside market, and others. Traders may regularly operate many such trading interfaces in order to track market conditions for a plurality of tradeable objects and execute various trading strategies simultaneously. The use of multiple interfaces with various numerical values can become burdensome to a trader who needs to accurately view and consider critical changes in the market conditions of a large number of tradeable objects. These interfaces require high levels of visual scanning, which makes it difficult to detect and analyze changes in market conditions on a real time basis as necessary to properly execute trading strategies. In short, the interfaces that are supposed to help the trader operate more efficiently and effectively can ultimately become overwhelming to the detriment of the trader.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates an exemplary trading interface for presenting market data which may be used to implement the disclosed embodiments.

FIGS. 5A and 5B illustrate exemplary trading interfaces for presenting market data and minimum order availability time information relating to a tradeable object which may be employed with certain disclosed embodiments.

FIG. 6 is a flow diagram illustrating an exemplary method for presenting market data and minimum order availability time information, among other things, relating to a tradeable object which may be employed with certain disclosed embodiments.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

The invention is generally related to systems and methods for providing trading interfaces that include trading tools and display market data in a manner which assists traders in quickly reviewing and processing information for the purpose of executing trades. Some embodiments of the invention are directed to systems and methods for displaying market data that are operatively configured to provide graphical or visual representations of a price collar, defining a boundary within which trades of a tradeable object may be executed. When a trade is determined to have occurred outside or beyond the price collar, current trading of the tradeable object may, for example, be suspended or only occur for a preset period of time at a predefined range of prices. The visual representations of such information reduces the amount of cognitive workload required to review, detect, process and monitor the market data, among other things, while also continuing to convey useful information that facilitates the execution of trades of tradeable objects.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways. Furthermore, well known process steps and computer components may have not been described in detail herein in order to avoid unnecessarily obscuring the underlying concepts.

### I. Brief Description of Certain Embodiments

Some embodiments of the invention are directed to a method for displaying market data that is facilitated by a computing device in communication with an electronic exchange and comprises the steps of displaying an interface format for presenting current market data in an area of a display device.

In one embodiment, the method for displaying indicators relating to market data includes receiving market data relating to a tradeable object trading on a market at an exchange and displaying a collar indicator at a value level of a value column, wherein the collar indicator corresponds to a value limit, and wherein the collar indicator is calculated as a function of an average traded price of the tradeable object. The method detects trade activity beyond the value limit and displays a duration indicator representing the time remaining in a collar time period, wherein the collar time period corresponds to a suspension in trade activity initiated in response to the detected trade. The method further sends a trade order for the tradeable object when the suspension in trade activity represented by the collar time period and the displayed duration indicator expires.

Some embodiments of the invention are directed to a system for displaying market data that includes a computing device in communication with an electronic exchange and a display device for displaying an interface format of current market data in a first area of the display device, wherein the first interface format may include all of the features described above and/or the features of the exemplary embodiments described herein below, and the computing device determines the order availability and displays visual representations as described above and/or by the features of the exemplary embodiments described herein.

Other embodiments of the invention are directed to a non-transitory computer-readable information recording medium that stores a program for controlling a computer to receive market data from an electronic exchange, the program comprising code for permitting the computer to perform the steps described herein including all of the features described above and/or the features of the exemplary embodiments described herein below.

### II. Example Electronic Trading System

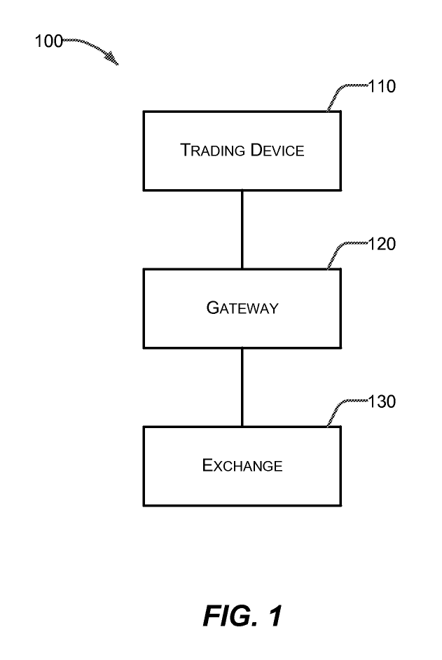

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market is the lowest available ask price (best offer) and the highest available bid price (best bid) in the market for a particular tradeable object at a particular point in time (since the inside market may vary over time). Market depth refers to quantities available at the inside market and at other prices away from the inside market. Due to the quantity available, there may be “gaps” in market depth.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange (for example, the exchange 130), a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object, a command to initiate managing orders according to a defined trading strategy, a command to change or cancel a previously submitted order (for example, modify a working order), an instruction to an electronic exchange relating to an order, or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL™, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may include computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a T1 line, a T3 line, an integrated services digital network (“ISDN”) line, a point-of-presence, the Internet, and/or a shared memory system, for example.

The gateway 120 may include one or more electronic computing platforms. For example, the gateway 120 may implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a virtual private network, a T1 line, a T3 line, an ISDN line, a point-of-presence, the Internet, and/or a shared memory system, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

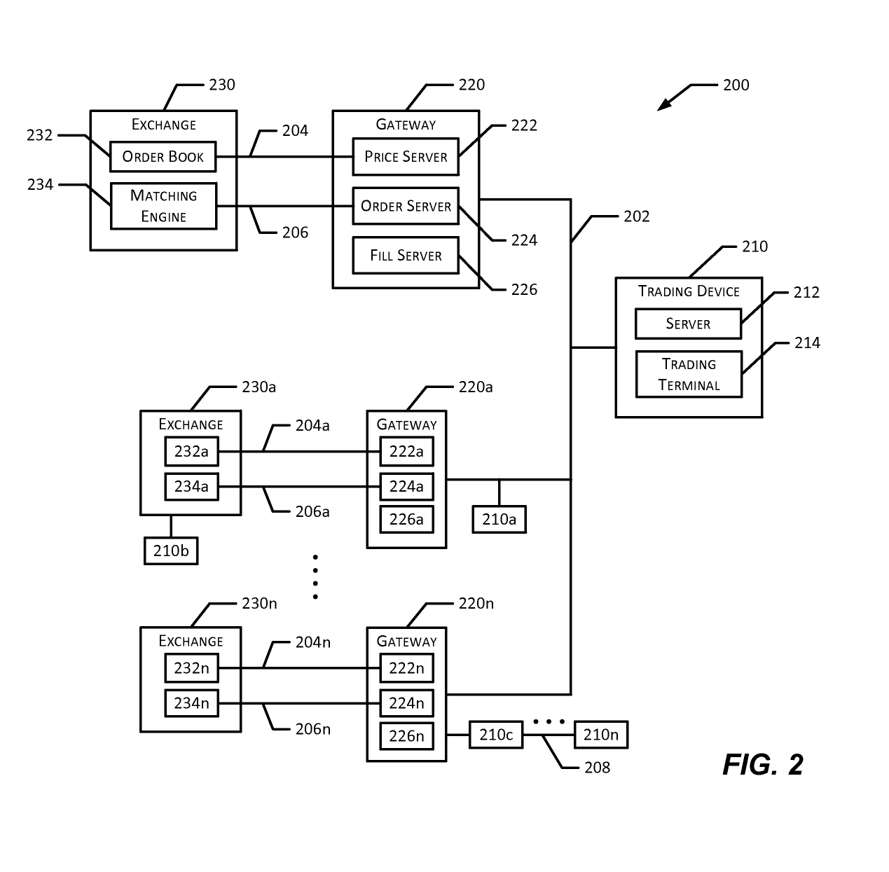

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 may utilize a network 202 to communicate with the gateway 220, and the gateway 220 can, in turn, utilize either of the networks 204 and 206 to communicate with the exchange 230. As used herein, a network is any communication network, including the Internet, which facilitates or enables communication between, for example, the trading device 210, the gateway 220 and the exchange 230.

The following discussion mainly focuses on the trading device 210, gateway 220, and the exchange 230. However, the trading device 210 may also be connected to and communicate with any number of additional gateways (individually identified as gateways 220a-220n) and exchanges (individually identified as exchanges 230a-230n) by way of the network 202. Additional networks (individually identified as networks 204a-204n and 206a-206n) may be utilized for communications between the additional gateways and exchanges. The communication between the trading device 210 and the additional exchanges 230a-230n may be the same, similar, or different than the communication between the trading device 210 and exchange 230. Generally, each exchange has its own preferred techniques and/or formats for communicating with a trading device, a gateway, the user, or another exchange. Similarly, each gateway may be in communication with one or more different exchanges, for example. Such an arrangement may, for example, allow one or more trading devices 210 to trade at more than one exchange (and/or provide redundant connections to multiple exchanges).

Additional trading devices 210a-210n, which are similar to trading device 210, may be connected to one or more of the gateways 220a-220n and exchanges 230a-230n. For example, the trading device 210a may communicate with the exchange 230a via the gateway 220a and the networks 202, 204a and 206a. In another example, the trading device 210b may be in direct communication with exchange 230a. In another example, trading devices 210c and 210n may be in direct communication with the gateway 220n via a shared communication connection or network 208. In certain embodiments, the network 208 may be a wireless or mobile network, a peer-to-peer network, a private network and/or proprietary network such as TTNET™ provided by Trading Technologies.

The trading device 210, which may be similar to the trading device 110 in FIG. 1, may include a server 212 in communication with a trading terminal 214. The server 212 may be located geographically closer to the gateway 220 than the trading terminal 214. As a result, the server 212 latency benefits are not afforded to the trading terminal 214. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include, additional, different, or fewer components. In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 may process order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data.

The exchange 230, which may be similar to the exchange 130 of FIG. 1, may include an order book 232 and a matching engine 234. The exchange 230 may include additional, different, or fewer components. The order book 232 is a database that includes data relating to unmatched quantity of trade orders. For example, the order book 232 may include data relating to a market for a tradeable object, such as the inside market, market depth at various price levels, the last traded price, and the last traded quantity. The matching engine 234 may match contra-side bids and offers. For example, the matching engine 234 may execute one or more matching algorithms that match contra-side bids and offers. A sell order is contra-side to a buy order with the same price. Similarly, a buy order is contra-side to a sell order with the same price. In certain embodiments, the additional exchanges 230a-230n may each includes instances of the order book 232 and the matching engine 234 (individually identified as the order book 232a-232n and the matching engine 234a-234n).

In operation, the exchange 230 may provide price data from the order book 232 to the price server 222 and order data and/or fill data from the matching engine 234 to the order server 224. Servers 222, 224, 226 may translate and communicate this data back to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, for example. For example, if the trading device 210 has been adapted to communicate directly with the exchange 230.

### IV. Example Computing Device

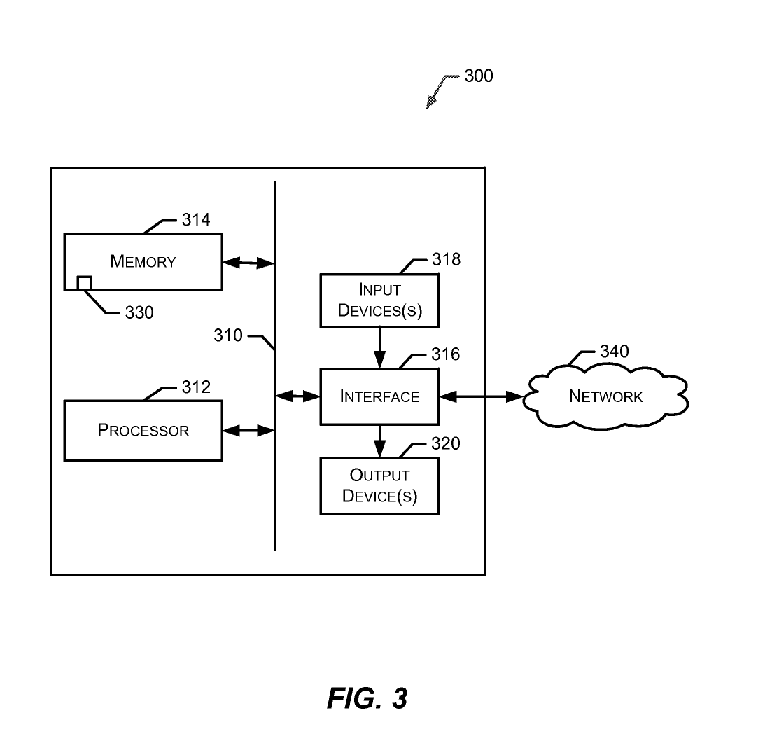

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Trading Interface

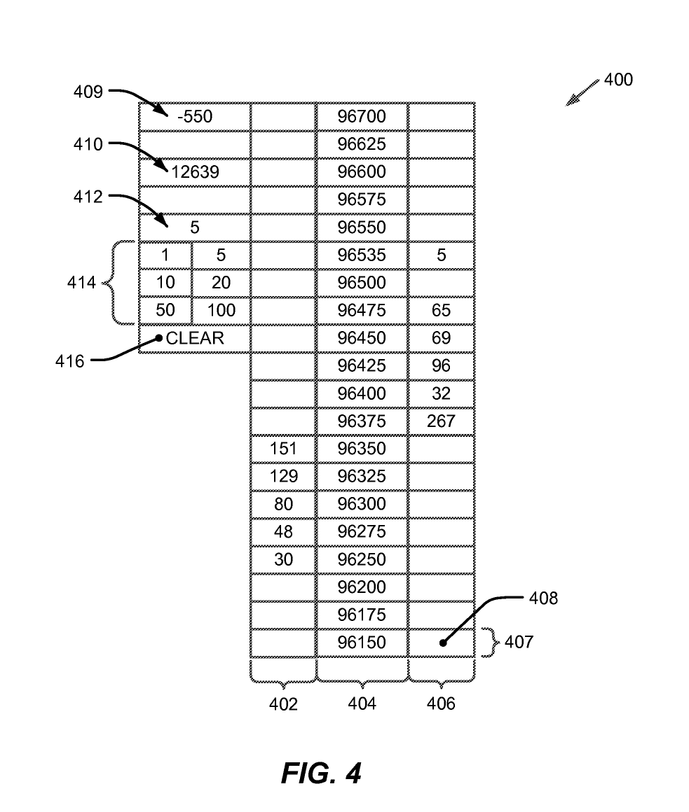

FIG. 4 illustrates an example trading window or interface 400 disclosed herein. While the following examples are described in conjunction with the example trading device 210 of FIG. 2 and the example electronic trading system 200 of FIG. 2, the examples disclosed herein may be implemented using any trading device in any other electronic trading system such as the example trading device 110 of FIG. 1.

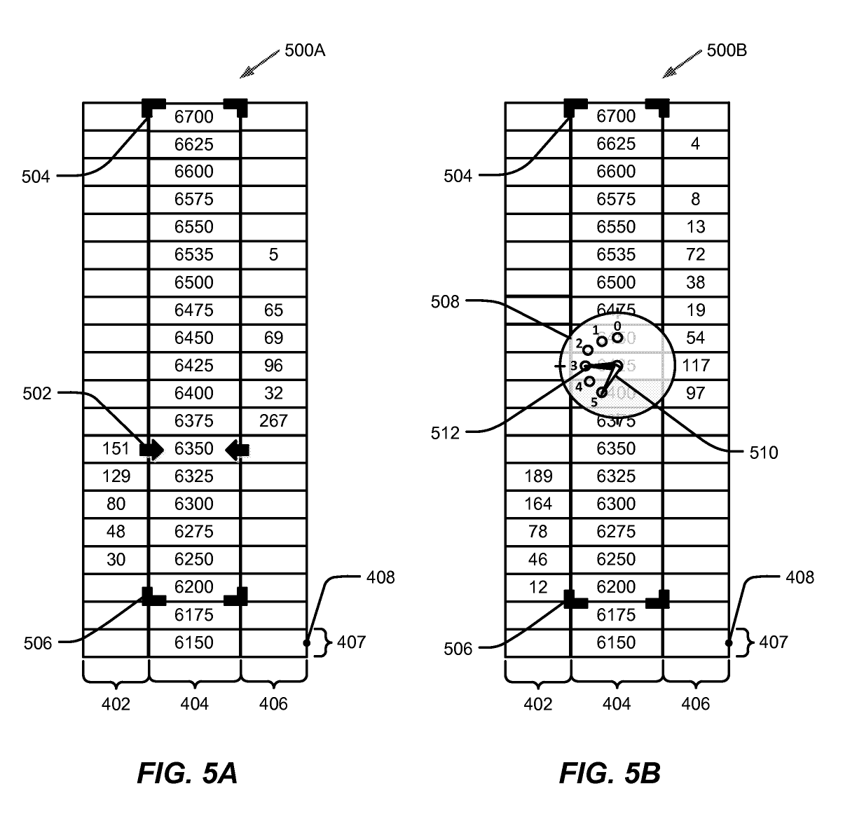

As described above in conjunction with FIG. 2, the example trading device 210 receives market data related to one or more tradeable objects from the exchange 230 and/or the exchanges 230a-230n through the gateway 220 and/or the gateway 220a-220n, respectively. The example trading device 210 provides a trading application to process and/or organize the market data and provide the example trading interfaces 500 (individually identified as trading interfaces 500A and 500B in FIGS. 5A and 5B). The example trading tool may be, for example, MD_TRADER®, X_TRADER®, one or more of the trading tools described in U.S. Pat. No. 6,772,132, filed on Jun. 9, 2000, which is hereby incorporated herein by reference in its entirety, and/or any other trading tool. The example trading device 210 displays the trading interface 500 to enable a user to view the market data, communicate trade orders, and trade actions with the electronic exchange 230 for execution.

In the illustrated example, the trading interface 400 includes a bid column 402, a value column 404 and an ask column 406. The example trading interface 400 of FIG. 4 also includes a plurality of rows 407. The example columns 402, 404 and 406 intersect with the example rows 407 to define a plurality of cells 408. In the illustrated example, the bid column 402 includes bid indicators such as the bid quantities of the tradeable object, the value column 404 includes value indicators arranged into value levels, and the ask column 406 includes ask indicators such as the ask quantities of the tradeable object. The bid quantity is a given quantity (e.g., 151, 129, 80, etc.) of the tradeable object in a bid to buy the tradeable object at a given price. The value levels can be configured to represent prices, derivatives of price, and other representations of value associated with the inside market and market depth. The ask quantity is a given quantity (e.g., 5, 65, 69, etc.) of the tradeable object in an offer to sell the tradeable object at a given price. In other examples, the bid indicators, ask indicators and/or value indicators are displayed in other orientations (e.g., horizontally) and/or via other organizational structures, and are not limited to numerical values.

In some examples, indicators corresponding to the inside market displayed in the bid column 402 and the ask column 406 move relative to the value levels displayed in the value column 404 when the highest available bid price (the best bid) and/or the lowest available ask price (the best offer) change according to market conditions.

The value levels in the value column 404 may be repositioned. In one example, the value indicators displayed in the value column 404 may be repositioned in response to a manual repositioning command. In another example, the value indicators displayed in the value column 404 may be repositioned automatically in response to an automatic repositioning command. The automatic repositioning command may, for example, be received upon detection of a triggering condition. Some examples of a triggering condition include: expiration of an alarm or timer; a determination that the inside market is, or may be, moving off the display; a determination that the inside market has exceeded an upper threshold or a lower threshold; an event in another trading interface; a market event relating to the same or a different tradeable object; a user-defined event; and/or a determination that a value exceeds a threshold.

The value indicators in the value column 404 may be repositioned. A selected value indicator may be repositioned to a designated location and other value indicators are repositioned relative to the selected value indicator. The selected value indicator may be based on, for example, a user selection or market related values such as the highest bid price or lowest ask price, LTP, and a calculated average of the best bid and best ask prices. The designated location may be a pre-determined location or a location defined by a user. In one configuration, the repositioning command may center the selected value indicator corresponding to the designated location corresponding to the middle of the display (e.g., to a location corresponding substantially to the midpoint of the length of the ask column 404). In another configuration, the repositioning command may not center the value indicators to the midpoint of the display but can move the value indicators to a user-identified or pre-defined position within the display.

In some examples, an indicator based on market data (such as best bid, best ask, LTP) is always displayed at the same fixed location. For example, the best bid indicator in the bid column 402 may be displayed at a specified fixed location. The fixed location may be pre-determined or defined by a user. For example, the best bid indicator and/or the best ask indicator may, for example, be maintained at the center of the display, at the top of the display, at the bottom of the display or any designated location.

In the illustrated example, the prices are displayed without decimal points and in descending order from a top to a bottom of the example value column 404 in the orientation of FIG. 4. In other examples, the prices are listed in other orders and/or formats (e.g., with decimal points, in scientific notation, and/or any other format).

In the illustrated example, the indicators in the bid column 402 and the ask column 406 are updated (e.g., substantially continuously or periodically) to indicate quantity changes at each value level identified along the value column 404. For example, values of the ask quantities and/or the bid quantities may increase or decrease due to order quantities being added, deleted or matched at each value level.

In some examples, the trading interface 400 includes additional and/or different information. In the illustrated example, the trading interface 400 of FIG. 4 also displays a net price change 409 of the tradeable object over a given amount of time (e.g., since the market opened on a given day). The example trading interface 400 also includes a current market volume 410 of the tradeable object (e.g., a number of lots that have been traded). Other examples include different and/or additional information.

The example trading interface 400 also enables the user to execute trades of the tradeable object via the electronic exchange 230. In the illustrated example, the trading interface 400 includes a quantity field 412. The quantity field 412 displays a quantity (e.g., 5) for an order that the user will send to market, and the user may adjust the quantity by selecting (e.g., via a mouse) one of a plurality of buttons 414 adjacent to the quantity field 412 or by entering a new value into the quantity field 412. If the user selects a button 416 labeled “CLEAR” in the illustrated example, the quantity field 412 is cleared (e.g., the quantity displayed in the quantity field 412 is adjusted to be zero).

The user may enter an order to buy or sell a tradeable object via a selection in an order entry area of the trading interface 400. The trading interface 500 may include multiple order entry areas. The order entry areas are configured to receive a selection to initiate placement of an order. The selection may be, for example, a single action of an input device such as a single or double click. Initiating placement may include sending an order to an electronic exchange. Each order entry area is associated with a particular value level.

In another embodiment, a user may link an order entry area and a particular value level such that selection of the order entry area initiates placement of an order at the linked value level. In one example, the user may select all or a portion of a value level, and then select the order entry area such as a buy button to complete the link and send a buy order. Similarly, the user may select all or a portion of a value level, and then select the order entry area such as a sell button to complete the link and send a sell order. In another example, the user may select an area in either of the bid or ask columns to link a desired value level to the order entry area such as a single order placement button. Selection of the single order placement button initiates placement of buy or sell order based on whether the selected area was in the bid or ask column, respectively, based on the linked desired value level.

In one embodiment, each order entry area may be aligned with one of the value levels. For example, an order entry area may be horizontally or vertically aligned with a value level such that selection of one of the areas initiates placement of an order based on the corresponding value level. In another embodiment, each order entry area may not be aligned with a value level. For example, a single order placement button may be positioned such that it is not aligned with a value level and may be linked to a particular value level.

The order entry areas may overlap one or more other order entry area defined within the trading interface. For example, each order entry area may encompass at least a portion of cells in the bid column, the ask column, and the value column.

As another example of the trading interface 400, order entry areas may include cells in the bid column 402. In another example of the trading interface 400, order entry areas may include cells in the ask column 406. Thus, separate order entry areas may be defined within another order entry area to initiate placement of buy or sell orders. In other configurations, multiple order entry areas may be defined. In one example, a first order entry area may include a second order entry area for initiating placement of buy orders and a third order entry area for initiating placement of sell orders.

In the illustrated example, an order entry area may include order entry areas in columns 402 and 406. Alternatively, a first order entry area may include order entry areas in bid column 402 and a second order area may include order entry areas in ask column 406. In operation, selection of an order entry area in bid column 402 initiates placement of an order to buy a default quantity at the value level corresponding to the selected order entry area, and selection of an order entry area in ask column 406 initiates placement of an order to sell a default quantity at the value level corresponding to the selected order entry area. For example, if the user selects the cell containing the bid quantity “129” in the illustrated example, the trading device 210 sends an order to sell a default quantity of 5 displayed in the quantity field 412 at a price of 96325. As another example, if the user selects the cell displaying the ask quantity “69” in the illustrated example, the trading device 210 sends an order to buy a default quantity of 5 displayed in the quantity field 412 at a price of 96450.

### VI. Trading Interface Including Data Visualization Indicators

Exemplary embodiments described below include various trading interfaces that present market data in a format that is intended to allow a trader to gain a fast, accurate, and comprehensive view of the current market conditions for a large number of tradeable objects through data visualization, among other things. It should be understood that market data is not limited to any particular types of data, and may include information received directly from the exchange 130 or data generated by the trading device 300 (as a function of the market data received from the exchange 130 or otherwise), for example.

FIGS. 5A-5B illustrate embodiments of the trading interface 400 including one or more indicators. The indicators may be selected and configured to represent trading information, values derived from the trading information and other trading related criteria. An indicator may be a symbol, an animated icon and/or an interactive interface element configured to assist a user in quickly visualizing, evaluating and comprehending trading information. In the illustrated embodiment shown in FIG. 5A, an indicator in the form of a pair of arrowheads 502 may identify an average price calculated between a first time and a second time. For example, the average price may be determined by computing a cumulative average price at which all trades of the tradeable object are executed over a known time interval. In certain embodiments, the cumulative average price may be a continuously determined value. For example, the cumulative average price may be determined based on the price of the tradeable object in all trades conducted during, for example, a five (5) minute time interval. Alternatively, the cumulative average price may be determined based on the average price of the tradeable object in a preset number of prior trades. In the illustrated example, the arrowheads 502 indicate that the cumulative average price is 6350.

In certain embodiments, indicators may be established to represent exchange defined price limits or price collars. Price collars represent exchange-established trading limits or boundaries. The trading limits may include upper price limits and lower price limits that define a range of value levels in which trades of a tradeable object may be executed. For example, one price limit may be calculated as a percentage change with respect to the current average price, the inside market, the last traded price or any other predefined trading parameter. In certain embodiments, high and low value limits or collars may both be calculated an equal distance (e.g., 5%, 10%, 4 price levels, 6 value levels, etc.) away from the currently calculated cumulative average price. In other embodiments, the high and low price limits or collars may be individually calculated. For example, the upper price limit may be a first percentage above from the cumulative average price and the lower price limit may be a second, different, percentage below the cumulative average price.

FIG. 5A depicts an example trading interface 500A that may be similar to the trading interface 400 shown in FIG. 4. The trading interface 500A illustrates market data a first time. The trading interface 500A includes an indicator in the form of brackets 504 that highlight an upper price limit established by the exchange. The brackets 504 highlight a value level corresponding to the value indicator 6700. In the illustrated example, the highlighted value level is five percent (5%) greater than the currently calculated cumulative average price of 6350. In other embodiments, the upper price limit may have been depicted as twelve (12) value levels above from the current average price. The trading interface 500A may include another indicator in the form of brackets 506 that highlight a lower price limit established by the exchange. The brackets 506 highlight a value level corresponding to the value indicator 6200. In the illustrated example, the highlighted value level is two and a half percent (2.5%) less than the currently calculated cumulative average price of 6350. In other embodiments, the lower price limit may have been depicted as five (5) value levels below the current average price.

FIG. 5B depicts an example trading interface 500B that illustrates market data a second time that is after the first time period shown in FIG. 5A. As market conditions change and market data is updated in the trading interface 500B, one of the price limits and/or price collars may be triggered, indicating that trading has occurred outside of the predefined range. When a trade occurs outside of the price collar, the exchange may halt, suspend, or otherwise restrict trading for a preset period of time. In this way, trading activity within a certain range defined by the price collar is encouraged.

In operation, when trading is halted or suspended, an indicator representing the remaining duration of the suspension is displayed as the timer 508. In the illustrated embodiment, the duration indicator is a timer 508 configured to represent a clock with a hand indicating the total time remaining in the current suspension. For example, the timer 508 includes a first hand 510 indicating that the total duration of the suspension is five (5) minutes and a second hand 512 indicating that three (3) minutes remain in the current suspension. In certain embodiments other indicators of the passage of time may be used that may include such as, for example, an hourglass timer, a countdown timer or other depictions incorporating changes in color and/or sounds. In other embodiments, the limits defining the price collar may be triggered based on, for example, volume traded over time, changes in market data and/or fluctuations in the current average price over time.

Trading interfaces of the invention such as interfaces 500A and 500B may incorporate user-friendly features and fit seamlessly with other operating system interfaces. That is, trading interfaces 500A and 500B may be in a framed form having borders, multiple folders, toolbars with pull-down menus, embedded links to other screens and various other selectable features associated with animated graphical representations of depressible buttons that may be selected (i.e., “clicked on” or “touched”) by the user via input device 318, which may include or comprise a connected mouse, keyboard or touch-enabled display device.

The embodiments herein describe new systems, methods and interfaces that allow a trader to better visualize the status of a large number of orders corresponding to a plurality of tradeable objects shown on their display screen.

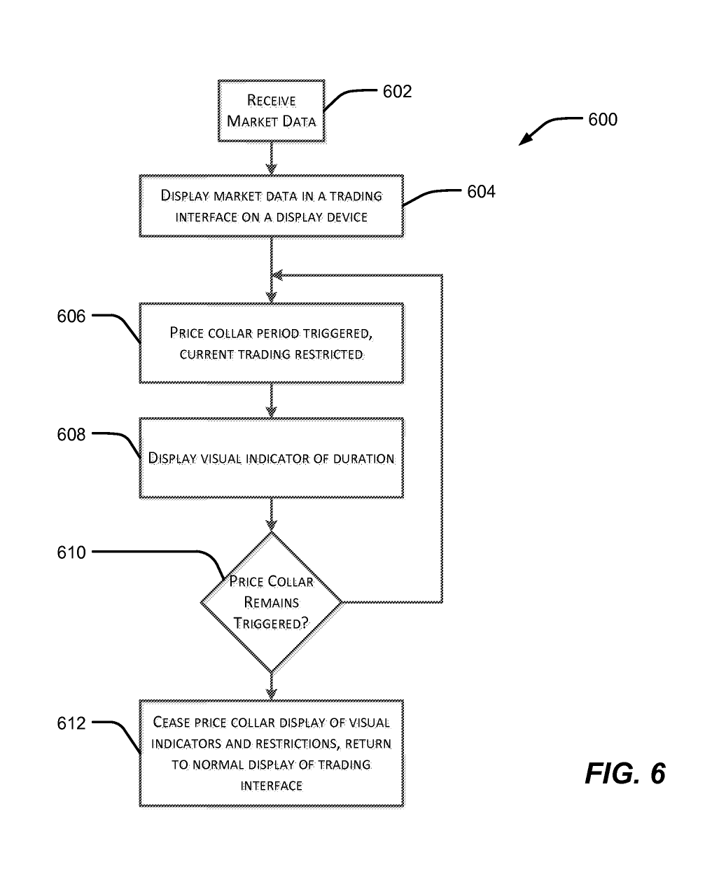

FIG. 6 provides exemplary functional steps of a method of carrying out the invention generally referred to as method 600 utilizing a computing device such as trading device 210.

At step 602, the method 600 begins with the receipt of market data for a tradeable object at, for example, the trading device 210. In an example, the market data may originate at the exchange 230 and be processed at the gateway 220 for delivery to the computing device 300. The market data and other trade related information may include one or more price limits used to establish a price collar. For example, the exchange 230 may have established price collars for one or more tradeable objects offered by the exchange. For example, the price collars could include an upper price limit and a lower price limit calculated with respect to the average price at which the tradeable object has traded over a defined period of time. In other embodiments, the price collar may be established with respect to the last traded price (“LTP”), the inside market, or another market parameter. In certain embodiments, the market data may be communicated to the trading device 210 and the current average price and price limits may be calculated at the device. For example, the trading device 210 may continuously calculate the current average price based on the market data received over a known period of time. The trading device 210 may, in turn, calculate the upper and lower price limits as a function of the calculated average price. In this way, the price collar may be continuously adjusted as the market data for the tradeable object moves throughout the trading period.

At step 604, market data is organized by a trading interface and displayed on a display device. For example, the received market data may be organized by the example trading application 330 and displayed via the trading interface 500A. The trading interface 500A displays prices for the tradeable object along with bid quantities or ask quantities for the displayed prices. The trading application 330 may further includes indicators identifying the current average price and the price limits associated with a price collar. For example, the trading interface 500A may include an average price indicator 502 and price limit indicators 504 and 506.

At step 606, movement of the market data beyond the upper and lower price limits established by the exchange triggers a suspension or pause in trading of the tradeable object. For example, when trading occurs outside of one of the limits of the price collar, a trading suspension or holding period may be initiated. In certain embodiments, trades beyond the upper price limit may result in a suspension of trading while trades below the lower price limit may result in a restriction of trading to value levels between the upper and lower price limits. Thus, movement of the market data may result in different outcomes depending on which price limit is reached.

At step 608, a visual indicator showing the remaining duration of a price collar time period may be displayed on the trading interface. The visual indicator may be overlaid and/or super-imposed over the trading interface. The visual indicator may be, for example, a countdown timer. The count down time may be represented as an analog clock having one or more hands indicating time or duration. During this time, trades through the trading interface may be restricted to prices within the upper and lower limits. In certain embodiments, market movement beyond one of the price limits may result in a suspension of trading for a period of time.

At step 610, the method 600 determines whether or not the price collar remains triggered, or a subsequent movement of the market data has triggered another price collar period. If the current price collar remains active or if another price collar period has been triggered, then the method 600 returns to step 606. However, if the current price collar has expired or if an additional price collar period has not been triggered, then the method 600 proceeds, the currently displayed visual indicators are removed, and the trading interface returns to its normal display of market data.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method for displaying indicators relating to market data, the method comprising:
receiving, by a computing device, market data relating to a tradeable object trading on a market at an exchange;
displaying, by the computing device, a collar indicator at a value level of a value column, wherein the collar indicator corresponds to a value limit, and wherein the collar indicator is calculated as a function of an average traded price of the tradeable object;
detecting, by the computing device, a trade beyond the value limit;
displaying, by the computing device, a duration indicator representing the time remaining in a collar time period, wherein the collar time period corresponds to a suspension in trade activity initiated in response to the detected trade; and
sending, by the computing device, a trade order for the tradeable object when the suspension in trade activity represented by the collar time period and the displayed duration indicator expires.

2. The method of claim 1, wherein the value limit includes an upper value limit and a lower value limit from the exchange, and wherein the upper value limit and the lower value limit correspond to a value collar established at the exchange.

3. The method of claim 1, wherein detecting a trade beyond the value limit further comprises:
receiving, by the computing device, a market data update relating to the tradeable object.

4. The method of claim 1 further comprising:
calculating, by the computing device, the average trade price relating to the tradeable object, wherein the average traded price is calculated between a first time and a second time.

5. The method of claim 1, wherein the collar indicator includes an upper value limit and a lower value limit.

6. The method of claim 5, wherein the value limits are calculated as a function of the average traded price.

7. The method of claim 5, wherein the upper value limit and the lower value limit define a range including a plurality of value levels.

8. The method of claim 1, wherein the duration indicator is a countdown timer.

9. The method of claim 1, wherein the collar time period is a five minute interval of time beginning from the detection of the trade activity.
